(19) United States
(12) Patent Application Publication
(10) Pub. No.: US 2002/0072412 A1
(43) Pub. Date: Jun. 13, 2002

(54) Online gaming with prize incentives

(75) Inventors: Neil C. Young, San Francisco, CA (US); Christopher D. Yates, Redwood Shores, CA (US); Christopher H. McKibbin, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronic Arts Inc., Redwood City, CA (US)

(21) Appl. No.: 09/859,262

(22) Filed: May 16, 2001

Related U.S. Application Data
(60) Provisional application No. 60/205,804, filed on May 17, 2000.

(51) Int. Cl. G06F 15/16; G06F 19/00; G06F 17/00; A63F 13/00; A63F 9/24

(52) U.S. Cl. 463/42; 709/205

(57) ABSTRACT

Systems, methods, and apparatus that provide an online gaming experience that is attractive to players and which provides an economic benefit to an application manufacturer or other party providing the online gaming system. In one embodiment, tokens are provided to players as currency to be used in the online gaming system of the present invention. The tokens may be issued for free, or they may issued for a fee associated with each token. In a further embodiment, an online currency account is maintained by the online gaming system for the players of the online gaming system. The players then submit a prize amount to be awarded the winner of the game. The prize amount is accompanied by a submission of the tokens necessary to comprise the prize amount. Alternatively, the online currency accounts for the players are debited by the corresponding amount. Each player may provide half of the prize amount, or any other percentage decided upon by the players (other percentages may reflect handicaps, etc.) or predefined by the online gaming system. In a further embodiment of the present invention, the tokens may be used to purchase goods online, either at a site hosted by the manager of the online gaming system or at other sites that have arrangements with the online gaming system manager to accept these tokens.

### CROSS-REFERENCES TO RELATED APPLICATIONS

This application claims priority to U.S. Provisional Applications Serial Nos. 60/205,804, filed May 17, 2000, the disclosure of which is incorporated herein by reference in its entirety.

### BACKGROUND OF THE INVENTION

The present invention relates generally to computer entertainment content delivery, and more specifically, to systems and methods for providing multi-player gaming over a network.

Currently, computer entertainment (“games”) provide the capability of head-to-head play over a direct connection, or a multi-player embodiment using a network configuration. Typically in these systems, a user is required to establish his or her own connection with an opponent, and the gaming experience is largely left up to the players involved. An application manufacturer or other online gaming system host who provides these features may host a service for allowing the players to connect with each other to play an online game, however, these services are usually free and provide no economic benefit to the application manufacturer or online gaming system host. If an application manufacturer or host charges a fee for playing a game online, many users possess sufficient technical understanding to conduct the game on their own through a direct dial-up connection and will thus avoid the fees. Thus, as online gaming becomes more prevalent as the preferred method of playing electronic games, application manufacturers will be unable to derive economic value from this aspect of their games and online gaming system hosts will be unable to derive economic value for this service. Therefore, what is needed is a business model for conducting online gaming that provides a method of deriving economic revenue for the online gaming system host or application manufacturer and remains attractive to players of the online game.

### SUMMARY OF THE INVENTION

The present invention provides systems, methods, and apparatus that enables an online gaming experience that is attractive to players while providing an economic benefit to an application manufacturer or other party providing the online gaming system. The players (or teams of players) of an online game submit a prize amount to be awarded the winner of the game. The prize amount is accompanied by a submission of online currency necessary to fund the prize amount. In one embodiment, the present invention provides tokens to players as online currency to be used in the online gaming system of the present invention. The tokens may be issued for free, or they may be issued for a fee associated with each token. In a further embodiment, an online currency account is maintained by the online gaming system for the players of the online gaming system from which online currency can be withdrawn to supply the prize amount. The prize amount may be decided upon by the players or predefined by the online gaming system, and each player may provide any percentage of the prize amount. The prize amount is also preferably accompanied by a percentage specification in which the percentage of the prize to be awarded the winner is specified. In a multi-player embodiment, for example, in a racing game, a winner may receive 80% and a second place finisher may receive 20%. Then, following the conclusion of the game, the prize amount is awarded to the players responsive to the specified percentages. Thus, the prize incentives of the present invention will encourage players to use the online game system, allowing the host to derive an economic benefit from providing online games. The host can specifically derive an economic benefit through the sale of the online currency to the players and also through retaining a percentage of the winnings. As the profit that is generated by the host is money derived from the winnings, the fee collected in this manner is more tolerable than a method in which a transaction fee is exacted for the simple playing of the game. Moreover, the present invention provides a negotiable prize amount to be awarded to a winner of a game. Allowing the prize amount to be mutually agreed upon by the players allows the online gaming system to be attractive to users of all income levels.

In one embodiment, the online gaming system monitors the game to determine winners, and in an alternate embodiment, the online gaming system is disengaged after the prize amounts and percentages are submitted, and the players submit the results to the online gaming system after the game is played. In an online currency account embodiment, the prize amount is added to the online currency account of the winners. In a further embodiment of the present invention, the tokens may be used to purchase goods online, either at a site hosted by the online gaming system host or at other sites who have an arrangement with the online gaming system host to accept these tokens for later reimbursement by the online gaming system host. Thus, the online gaming system host may also derive economic benefit through selling goods in exchange for the online currency that was won by playing the online games. Finally, in one embodiment, the online gaming system maintains a database for different players storing records of their gaming history, and this information is automatically provided when the player participates in an online game. This embodiment allows the online gaming system host to build player loyalty to the online gaming system, as only the online gaming system has access to the player history. Thus, a system, method, and apparatus are provided for providing an online gaming system while generating an economic benefit to the online gaming system host.

### BRIEF DESCRIPTION OF THE DRAWINGS

FIG. 1 is a block diagram of an online gaming system with prize incentives.

FIG. 2a is an illustration of a user interface for initiating an online game.

FIG. 2b is an illustration of a user interface for configuring payment of a prize amount for an online game.

FIG. 2c is an illustration of a user interface for obtaining payment of a prize amount.

FIG. 3a is an illustration of an online currency account database. FIG. 3b is an illustration of a user interface for an online currency account provided to a player.

FIG. 4 is an illustration of a player history database.

FIG. 5 is a flowchart illustrating enabling an online game with prize incentives.

FIG. 6 is a flowchart illustrating allocating tokens to a prize field.

FIG. 7 is a flowchart illustrating enabling a pre-configured online game with prize incentives.

### DETAILED DESCRIPTION OF PREFERRED EMBODIMENTS

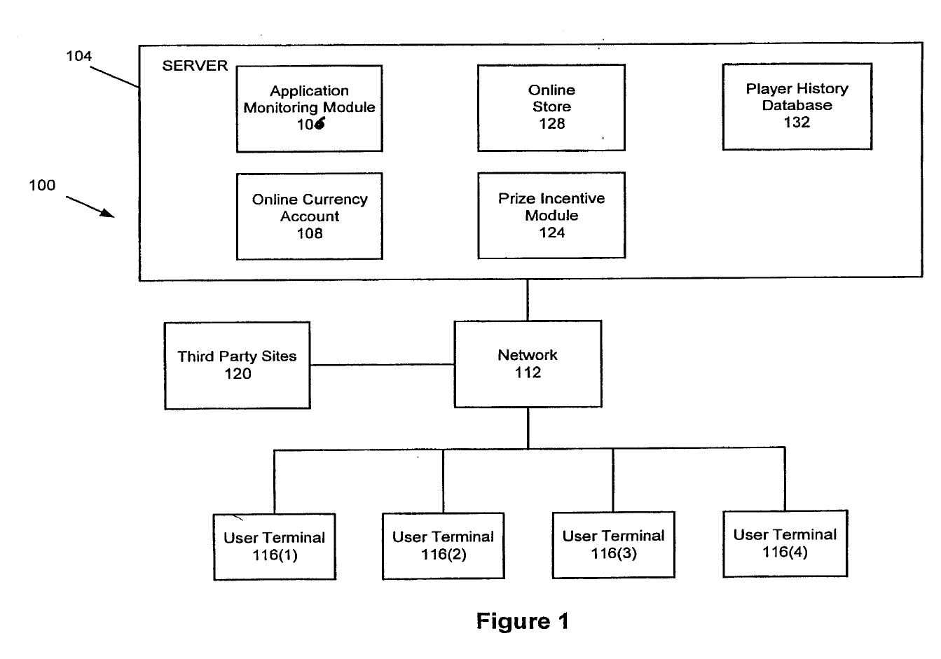

Referring to FIG. 1, a system 100 for providing online gaming with prize incentives is illustrated. A plurality of user terminals 116 are coupled to a network 112, typically the Internet, but any local-area or wide-area network could also be used. The user terminals 116 are typically personal computers or similar computing devices; however, “dumb” terminals connected to a server or the like may also be used in accordance with the present invention. The user terminals 116 typically store an application module that provides a gaming experience. Application modules can include sports-related games (e.g., football, golf), skill-related games (e.g., cards, chess), fight-based games or other games in which two or more players compete against each other. The present invention is applicable to games in which individuals compete against each other (players play as individuals) or to games in which individuals compete in teams against other teams.

A server 104 is connected to the network 112. In the illustrated embodiment, a single server 104 is shown; however, multiple servers or other configuration variations could also be used in accordance with the present invention. In a preferred embodiment, the server 104 comprises an online currency account 108, a prize incentive module 124, a player history database 132, and at least one application monitoring module 106. An online store 128 is also provided in a preferred embodiment, as discussed below. Third-party sites 120 may also be used in conjunction with or in place of an online store 128 as discussed below.

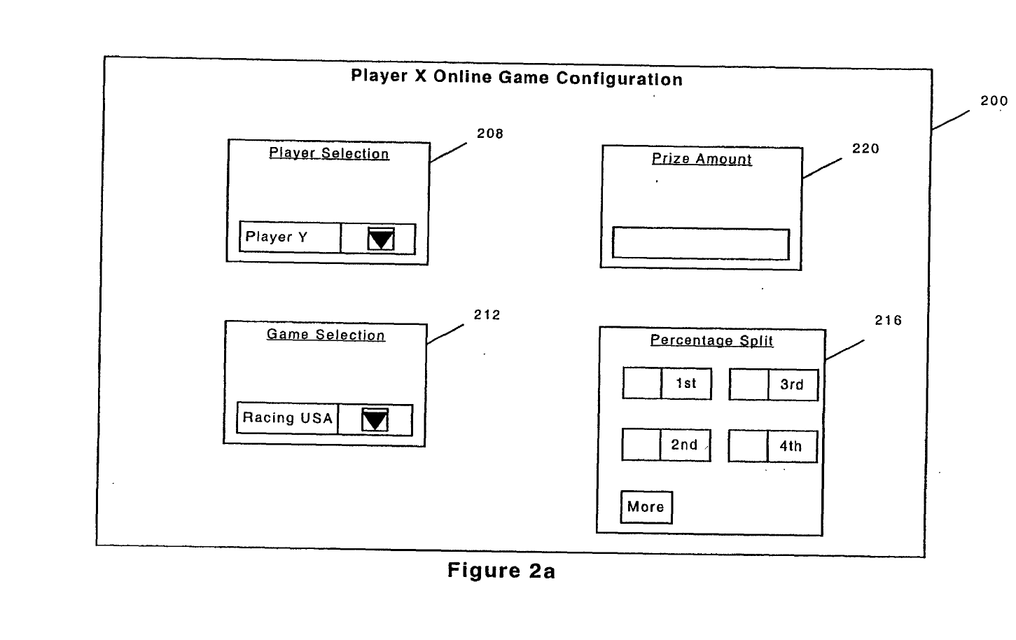

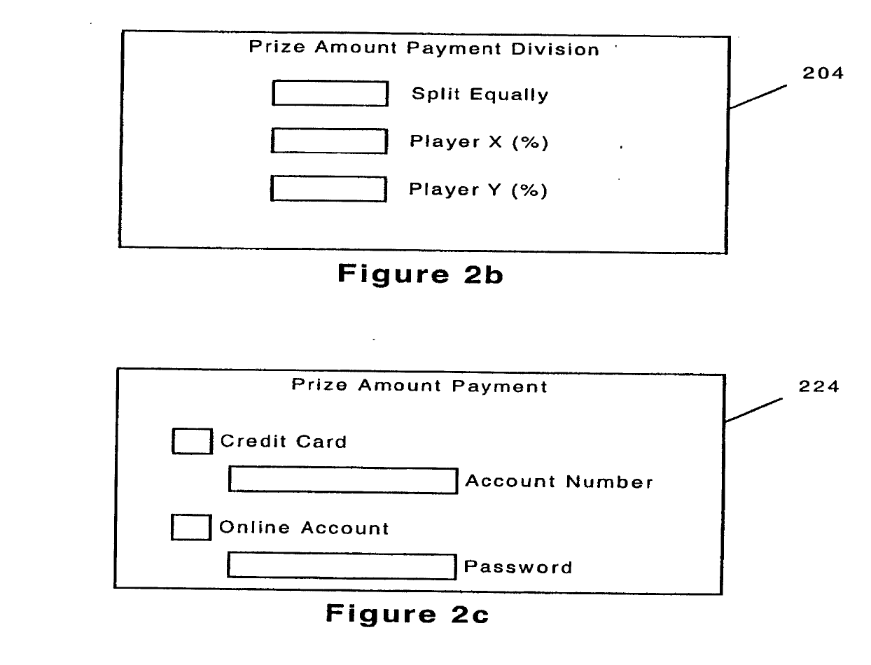

Players who wish to participate in the online gaming system 100 of the present invention initiate a connection from their user terminal 116 to their internet provider or other network connection facility, and specify the address of the server 104. In one embodiment, the players must have a password to access the server 104, and in this embodiment the players connecting to the server 104 enter their passwords and are identified by the server 104. Once connected to the server 104, the prize incentive module 124 displays a user interface 200, such as the exemplary interface shown in FIG. 2a, to the players to enable the online game with prize incentives. In one embodiment, one of the players is the lead player, and is designated by the group of competing players to configure the online game. In this embodiment, only the lead player interacts with the user interface. In an alternate embodiment, each player configures the game, or parts of the game separately.

FIG. 2a illustrates one embodiment of an online game configuration interface 200. The prize incentive module 124 displays the online game configuration interface 200 to the lead player, preferably displaying the player's name at the top of the interface 200 to ensure that the correct player has been identified by the password. As part of the online game configuration screen, the prize incentive module 124 displays a player selection window 208 to the lead player. In FIG. 2a the player selection window 208 is illustrated as a pull-down menu. In a preferred embodiment, the entries in the menu are the player identifications of all players currently connected to the server 104 but not actively playing in an online game. This is the “pool” of available opponents. The lead player selects names from the pull-down list to participate in the game to be played. If the lead player has connected to the server 104 in order to compete against friends, the lead player will select the player IDs of the friends. A message is sent by the server 104 to the user terminals 116 of the selected players asking whether they would like to participate in the game with the lead player. The message is preferably sent using an instant-messaging facility, or the like. Upon receiving confirmation from the selected players, the prize incentive module 124 stores the player IDs of the selected players in a temporary storage area.

In one embodiment, the online gaming system 100 enables players unknown to each other to meet and play. In this embodiment, the prize incentive module 124 generates a “Meet Potential Opponent” option. Upon selecting this option, a page is displayed to the players that illustrates the player IDs of all other players who have also selected the “Meet Potential Opponent” option. In this page, a chat room is provided to allow players to meet and determine with whom they would like to compete. Once the players have agreed on a group, a lead player and other online game configuration information, the lead player configures the online game using the main interface 200. Thus, the online gaming system 100 of the present invention provides an easy method for players to engage in an online game even if they do not have a partner.

After selecting players, the lead player selects a game from a game selection window 212. The game selection window 212 in FIG. 2a is also displayed as a pull-down window. A list of available games is provided, and the lead player selects the agreed upon game. In one embodiment, the server 104 stores server or host copies of the games, and the users play the game by interacting with client versions of the game on their own user terminals, and transmit packets of data to the server 104. The server 104 updates the copy of the game designated for the group of players accordingly, and transmits the updated game information to the players for display through their copy of the game. In this embodiment, the prize incentive module will display all of the games for which the server 104 has server copies in the game selection window 212. However, in an alternate embodiment, the server 104 enables a connection between the competing players, and one of the application modules on one of the players' user terminals acts as a “server” version of the game. In this embodiment, a game selection window 212 need not be used.

After selecting the game and players, the lead player accesses the prize amount window 220. In this window 220, the lead player specifies the total amount at stake for the game. The prize amount can be any amount the players agree upon. This is in contrast to conventional non-interactive systems (such as “skee-ball”) in which predefined prize amounts are dictated to players. In these conventional systems, the prizes may be too low for some people to provide an economic incentive to play, and may be too high for other people, and either case may discourage play. However, in the system of the present invention, the players themselves can determine the prize amount. Thus, if two professionals are playing a game of skill enabled by the server 104 of the present invention, they may wager $500.00 on the outcome. In contrast, if two high-school age students want to play, they may wager $10.00 on the outcome. Thus, the prize amount can be tailored for whomever wants to play, and therefore the online gaming system 100 can provide an attractive game for the maximum number of potential users. In one embodiment, the prize amount is determined from a previously-stored online game configuration, discussed below. In an embodiment in which the players are competing in an online tournament, the online prize amount may be determined responsive to the round in which the players are competing. In a tournament embodiment, a different user interface designed for the online tournament may be used in place of the online game configuration interface 200.

After the prize amount is specified, the lead player specifies the percentage split of the prize in the percentage split window 216. In the illustrated embodiment of FIG. 2a, four entry boxes are provided to specify a percentage to be awarded for first through fourth place finishers. A “more” button is provided to allow the players to specify a split for additional place finishers. If the game is a head-to-head game, like boxing, then the percentage for 1st place would be specified as 100%, and, in one embodiment, the default value of 100% is pre-assigned to the 1st place entry box. However, if a racing game allows 10 players to compete, the present invention allows the total prize amount to be split proportionately amongst the top 3 finishers, or whatever number the players decide. Again, the online gaming system in accordance with the present invention provides the ability for the users to customize the prize incentive scheme to match their own preferences, and therefore enables the system of the present invention to be attractive to as many potential players as possible. After the information in the online game configuration screen 200 has been entered, a provisional acceptance screen is displayed to all players. All players selected then have the opportunity to confirm the selections made by the lead player.

In FIG. 2b, an exemplary user interface 204 is shown in which the prize incentive module 124 displays several options to the lead player for splitting the payment of the prize amount. In a preferred embodiment, after the players have been specified in the online game configuration interface 200, the player IDs of the players so specified are listed in the prize amount payment interface 204. In one embodiment, the prize incentive module 124 automatically displays the payment split choice of splitting the payment equally among all players. Custom percentage split entry boxes are also displayed for each player selected in the online game configuration interface. Thus, in contrast to conventional systems, the present invention provides custom tailoring of the prize incentive to the needs of particular players, for example, players of differing ability are able to select a division of the payment of the prize amount corresponding to that ability, or players of differing economic backgrounds may select a payment division mutually agreed upon to represent their differing abilities to pay. As with the online game configuration interface 200, the prize amount payment interface 204 is displayed to all players to accept the choices selected by the lead player.

FIG. 2c illustrates an exemplary user interface 204 displayed by the prize incentive module 124 to each player for obtaining prize amount payment. In an embodiment in which an online currency account 108 is provided, the prize incentive module 124 displays options to debit the prize amount from a credit card account or an existing online account 108. In an alternate embodiment, only online currency is accepted by the server 104, and the players must purchase online currency before initiating an online game. The online currency may be purchased from the server, which then creates an online currency account for the player and credits the account with the amount of online currency purchased. In this embodiment, the obtaining prize amount window 224 is not required, as the prize amount is automatically debited from the player's online account. Although shown as a single interface, the elements of the above interfaces 200, 204, 224 could be combined or divided into other interfaces.

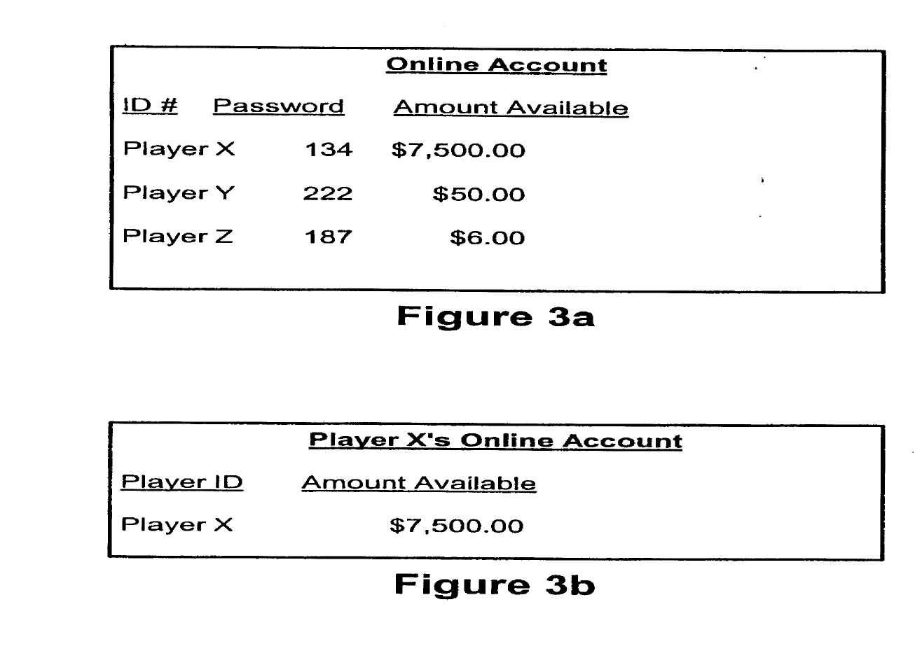

FIG. 3a is an illustration of an online currency account database 108 maintained by the server 104. In the data structure, fields are maintained for each player ID, for passwords required to access the account, and for the amount of online currency available to each player. In a preferred embodiment, the available amount is determined by the amount deposited in the account less any amount provisionally withheld pending the outcome of an online game. The provisional amount is withheld to prevent a player from over-extending finances through the playing of multiple games at once. For example, a player may want to participate in several online card games at the same time, and in that situation, the player prize amount for each game is provisionally debited from the player's account. Thus, if the player wished to participate in a new game, only the amount not subject to forfeiture is available to the player for wagering in the new game. The prize incentive module 124 maintains the provisional amount in a separate field. FIG. 3b illustrates an interface 300 displayed to a player showing the player's online account 108. Access to this screen is permitted only through the entry and acceptance of a password.

Thus, the use of an online currency account 108 enables easy and secure transactions between the users and the online gaming system 100. A player can set up an account 108 once, and then for future wagers in the online game system, simply have the amount debited from the player's account 108 without requiring the player to re-enter information. Additionally, once currency is in a player's account 108 the system 100 does not have to revalidate a player's ability to pay as long as sufficient currency is in the player's account 108. To ensure safe transactions, the deposits to an online currency account 108 can use any commercially available encryption systems to provide a safe transfer of money. The transfers between online accounts 108 after a prize is won are accomplished by the server 104, and therefore provide a very safe method of exchanging money between players. If the system includes an online store 128 maintained by the server 104, then the transactions between the player and the store remain secure as purchases made at the store can be facilitated by directly deducting the amount from the online account 108. Although one sequence is described herein for configuring an online game, other sequences could be used to configure an online game in accordance with the present invention. For example, the lead player may select a game first, or the prize amount first, or perform any of the other steps described above in a different order than what is described above.

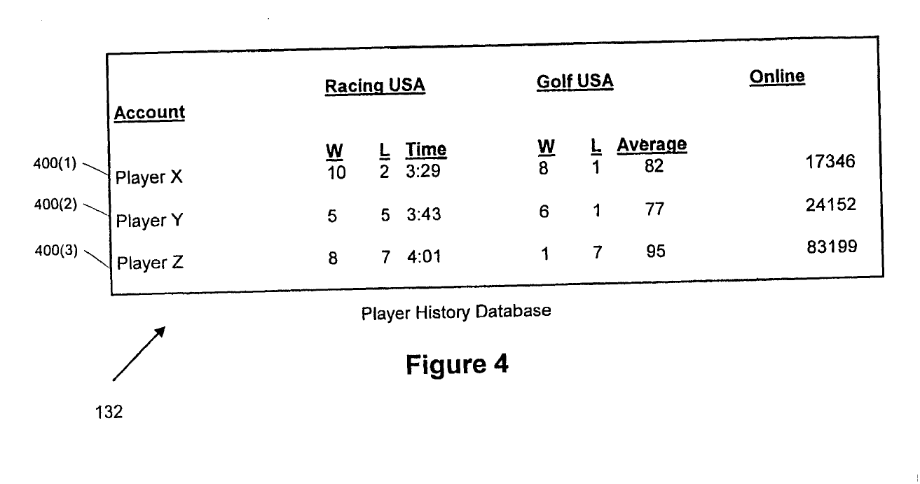

FIG. 4 illustrates a player history database 132. The player history database 132 maintains database fields 400 to store information regarding players who have previously used the online gaming system 100. In the illustrated embodiment, the player history database 132 maintains in a field 400 the name of a player, outcomes in different games, average results in those games, and a link to the player's online account (in one embodiment, the online account 108 can be combined with the player history database 132). Any other information regarding the history of transactions and the games can also be maintained in a database field 400. By maintaining the player history database 132, the online gaming system 100 can provide a more efficient and more personal gaming experience. For example, if Player X would like to know how he or she has fared in Racing USA, the prize incentive module 124 can retrieve the won-lost record and fastest time information and display it to the player. Storing this information builds a loyalty to a web site because no other web site has access to this information. Another benefit to players is that they can note trends in their play. If they seem to be losing too often in Golf USA, they may decide to stop playing and concentrate on another online game requiring different skills, such as bridge. In one embodiment, once players are selected in the online game configuration interface 200, the records of the players for the relevant game are displayed to all of the selected players to allow them to determine the prize amount and split. This allows players to know the skill level of the players with whom they compete, some of whom may be strangers, and allows them to adjust their prize amount and split accordingly. This also may result in a player with an extremely impressive record being required by other players to pay a higher percentage of the prize amount, thus, in effect, giving odds to the other players. The prize payment percentage can also be auto-suggested by the prize incentive module 124, responsive to analyzing the relative records of the players competing in the game.

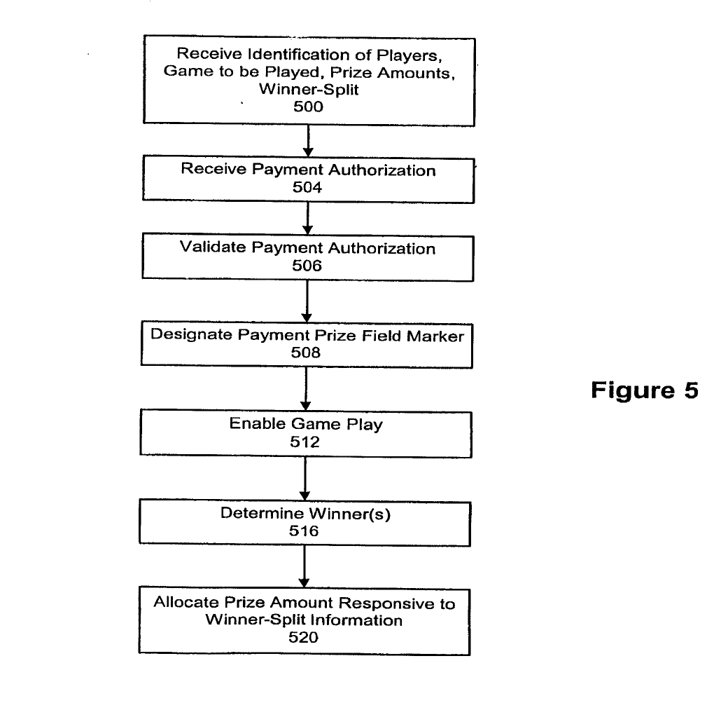

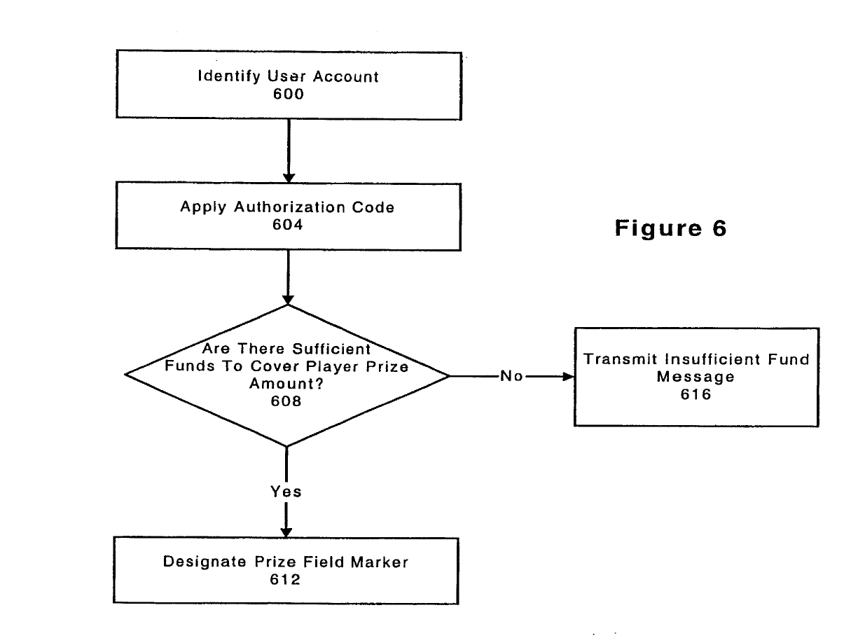

FIG. 5 is a flowchart illustrating a method of enabling an online game with prize incentives. First, the prize incentive module 124 receives 500 an identification of the players, game to be played, prize amount, and winner split from a user, in an embodiment where all of the above information is required. As discussed above, this may be accomplished by entry of the information by a lead player through an online game configuration interface 200, but other interfaces or methods may be used in accordance with the present invention. Then, the prize incentive module 124 receives 504 a payment authorization for the prize amount from the players providing the prize amount. As discussed above, this may be through the use of an online currency account 108, virtual tokens representing legal tender that are provided by a third party and accepted by the online gaming system, a credit card authorization, or other payment means. Next, the payment authorization is validated 506 to ensure the amount to be paid by the player as determined by the percentage split and prize amount information is actually available. As shown in FIG. 6, the user account is identified 600, preferably through the use of an interface 224 as shown in FIG. 3c. Then, the authorization code is applied 604 to the account. If a credit card is used, the credit card number is used to access the player's credit card account. If an online account 108 is being used, a password is used to access the online account 108. Then, the system determines 608 whether the amount requested is available. If the online account 108 or credit card account indicates that the amount requested is not available, or other error (for example, a password being incorrect), an insufficient fund message is transmitted 616 to the player. If the authorization is successful, a marker representing the amount of payment owed by a player is set aside 508 in a prize field designated 612 for the online game about to be played. The prize field is a data structure that holds the prize amounts specified by each player to be paid pending the outcome of the game. In addition, the prize amount to be set aside is deducted from the amount available field of the user's account 108, as discussed above, to indicate the amount of money available to the user not subject to forfeiture.

Referring back to FIG. 5, in an embodiment in which the server 104 is negotiating the connection between the user terminals 116, the server 104 then enables 512 game play. This is accomplished through conventional means, in which the server 104 maintains a version of the game, receives data from the players, and transmits back the results. An application monitoring module 106, preferably separate from the component of the server 104 that enables the games, determines 516 the winners of the game. The application monitoring module 106 is preferably separate to allow a more simple version of the online game play to be used when no prize incentive technology is required. For example, a single web site may enable prize incentive games and ordinary online games, and in this embodiment, the modules in the server 104 that enable the online game between players are not required to be modified as discussed above. However, if prize incentives are enabled, then upon termination of the game, the application monitoring module 106 accesses the server host version of the game to determine the winners.

In a preferred embodiment, there is an application monitoring module 106 for each online game that is being played. The application monitoring module 106 communicates the winner information to the prize incentive module 124. The prize incentive module 124 then allocates 520 the prizes to the players in accordance with the outcomes. Thus, for players who owe money, the markers stored in the prize field associated with that game are used to retrieve the amount wagered from the player's accounts. Then, the money is transferred to the players who won, in accordance with the percentage split. In an embodiment with an online account 108, the prize amount is debited from one account and credited to the other. In one embodiment, the prize amounts are actually withdrawn from the user accounts 108 in the validate payment authorization step 506, and then when the prizes are determined, the prizes are transferred from the prize field to the winners' account directly. In an embodiment in which credit cards are used for payment, the accounts of the players who had a net loss responsive to the outcome of the game are charged responsive to their prize amount percentage information. The players who had a net gain responsive to the outcome of the game have their accounts credited with the appropriate amounts. The net loss or gain is determined by the difference between the amount won (if any) and the amount wagered.

In a further embodiment, the online gaming system derives an economic benefit from providing the online games by charging a fee for playing the game. In this embodiment, a flat fee in online currency may be charged per game, and withdrawn from players' online accounts. However, in contrast to conventional systems, players may not view this fee as being burdensome because it is being subtracted from a prize to be won and the winner(s) of the prize will be earning a profit overall.

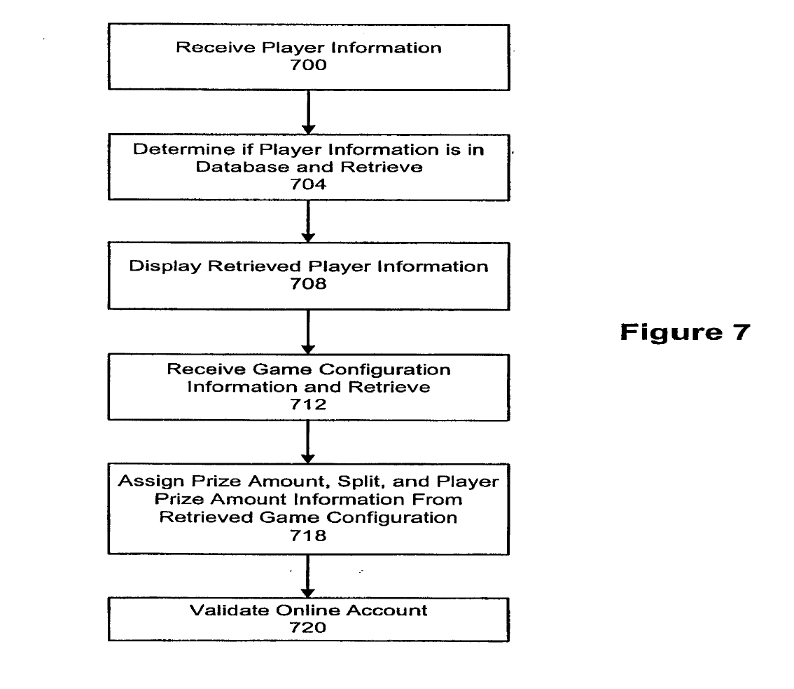

FIG. 7 is a flowchart illustrating enabling a pre-configured online game with prize incentives. First, the prize incentive module 124 receives 700 the player identification information from the players. Then, the prize incentive module 124 determines 704 whether the player has a database field 400 in the database 132. If the player does, then the information is retrieved and displayed 708 to the player. As discussed above, the player information to be displayed may include won-loss records, a current account 108 balance, or other information about the player's history in the online gaming system. Then, in one embodiment, online game configurations are displayed to the player. The online configurations are preferably derived from previous online game configurations used by the player. In one embodiment, any game configuration in which a player participated is stored in the player's database fields 400. In a preferred embodiment, selective configurations are stored. Selective configurations may include only those game configurations in which a player was a lead player, configurations that are used frequently by that player, or those in which a player chooses to have the configuration stored in the player history database 132. If a player selects a predefined game configuration, the prize incentive module 124 receives 712 the predefined game configuration information and then assigns the prize amount, split, and player prize amount information from the fields of the database 132 corresponding to the predefined configuration. All or some of the different customizable aspects of the online game configuration can be stored and retrieved. Any fields not stored are displayed to the lead player for entry. The validation step 720 is still performed as the amounts in an account should be verified by the prize incentive module 124 before each game. Thus, by pre-storing configurations, players who regularly compete with other players can quickly access the game in the prize incentive configuration they prefer.

In one embodiment, the online gaming system 100 of the present invention includes an online store 128. In this embodiment. the online currency provided to players is also accepted at the online store 128 in exchange for goods. For example, if the online currency is provided as tokens, at an exchange rate of 4 tokens for a dollar deposited in the online account 108, then goods may be provided to the player in terms of the tokens. For example, a baseball cap may be offered for 40 tokens. As discussed above, the use of tokens ensures that the monetary exchange is secure, because the validation of the user's finances has already occurred when the user deposited money into the online currency account 108. Thus, the user can select an item in the online store, and the online system can then check the online account 108 as described above to determine if there are sufficient funds. If there are, the tokens are withdrawn from the user's account 108, and the goods are delivered to the user. Thus, a seamless system for providing price incentives for games using online currency and then purchasing goods using the online currency won is provided in accordance with the present invention to enable an application manufacturer or online gaming host to derive revenue from their online gaming services.

In one embodiment, online currency tokens awarded to the winner can only be used to buy goods in the online store 128. In this embodiment, the online gaming system host derives economic benefit from providing the online game when the player purchases goods from the online store. In an alternate embodiment, the online gaming system host can enter into a contractual arrangement with one or more third party e-commerce site (s) 120, in which the third-party site will accept the online currency of the online gaming system. In this embodiment, if a user presents online currency such as a token to the third-party site, the third-party site treats the token for its nominal monetary value and allows the user to purchase goods. Then, the third-party site can request all or partial reimbursement from the online gaming system host. The profits from any purchases made by the players on the third-party site can be divided between the third-party site and the online gaming system host. Alternatively, the value of directing potential future customers to the third party site may be exchanged for any profit made on the sale of goods. Thus, the online gaming system of the present invention provides several methods of deriving economic revenue from online gaming while maintaining the online gaming system as an attractive arrangement to the players of online games.

It is to be understood that the specific mechanisms and techniques that have been described are merely illustrative of one application of the principles of the invention. Numerous additional modifications may be made to the apparatus described above without departing from the true spirit of the invention. Moreover, although specific functionality has been ascribed to different steps of the above described method and modules of the above described circuitry, these functionalities can be performed in different orders and by different modules as would be known to one of ordinary skill in the art.

What is claimed is:

1. In a network comprising a content server and a plurality of connected user terminals, a method of providing online gaming involving multiple players comprising:
receiving a request to initiate an online game;
identifying at least two players to participate in the online game;
enabling the online game to be played by the identified players;
determining a winner of the online game; and
delivering at least part of a specified prize amount to the winner.

2. The method of claim 1 further comprising:
receiving a specification of the prize amount from at least one of the players.

3. The method of claim 1 further comprising:
determining the prize amount for winning the online game.

4. The method of claim 3 wherein determining the prize amount comprises:
retrieving the prize amount from a stored online-game configuration associated with at least one of the players.

5. The method of claim 1 further comprising:
retrieving an amount to be allocated to a first-place winner from a stored online-game configuration associated with at least one of the players; and delivering further comprises:
delivering an amount to a first-place winner responsive to the retrieved amount.

6. The method of claim 3 in an online tournament in which players compete in a plurality of rounds, wherein the prize amount is determined responsive to the round of the tournament the players are competing within.

7. The method of claim 1 further comprising the step of:
receiving an identification of a game to be played selected from a predefined list of games.

8. The method of claim 1 wherein the step of identifying players further comprises the step of:
providing a site for players to select partners with whom to compete.

9. The method of claim 1 further comprising:
receiving access to payment equivalent to the specified prize amount.

10. The method of claim 9 wherein receiving access comprises:
receiving from a player a credit card identification and authorization to charge a credit card so identified for the payment.

11. The method of claim 9 wherein receiving access comprises:
receiving an online account identification and authorization to debit an online account so identified for the payment.

12. The method of claim 9 wherein receiving access comprises:
receiving at least one digital token representing an amount equivalent to the specified prize amount.

13. The method of claim 1 wherein delivering at least part of the prize amount comprises:
delivering the prize amount less a transaction fee to the winner.

14. The method of claim 1 wherein delivering at least part of the prize amount comprises:
delivering an amount of the prize amount to the winner responsive to a predetermined percentage designated as a winner's share of the prize amount.

15. The method of claim 1 wherein enabling the online game comprises:
establishing a connection between the at least two players to allow information to pass from a computer of one of the at least two players to a computer of another of the at least two players.

16. A method of providing an online game system comprising:
receiving an identification of a lead player;
providing an online game configuration interface to the lead player;
receiving from the lead player online game configuration information for a multiple-player game, the information including prize information;
enabling the online game between identified players;
providing a prize corresponding to the prize information to at least one winning player of the online game.

17. A method of providing an online game system comprising:
receiving online currency to be used to fund a prize amount for at least one winner of an online game from at least two players of the online game; and
awarding at least a portion of the prize amount to at least one winning player of the online game.

18. The method of claim 17 wherein online currency is stored in an online account for a player of an online game and receiving further comprises:
receiving a specification of an amount to be withdrawn from an account of at least one player of the online game to be used as at least part of a prize amount for the online game.

19. The method of claim 18 further comprising:
verifying the amount specified is present in the account of the at least one player.

20. The method of claim 19 further comprising:
withdrawing the specified amount from the account.

21. The method of claim 17 in a system in which all players of the game have an online account, and receiving further comprises:
receiving at least one specification of an online account from at least one player of the online game.

22. The method of claim 21 further comprising:
receiving an identification of an amount to be withdrawn from an online account in response to a player not qualifying for an award of a prize.

23. The method of claim 22 further comprising:
debiting the specified account for an amount equal to the identified amount.

24. The method of claim 22 further comprising:
crediting an account of a winner of the online game with an amount corresponding to the prize amount.

25. The method of claim 22 further comprising:
receiving a prize amount designation from at least one player, wherein the prize amount designation specifies an amount of online currency which will be awarded to a winner of the online game; and
crediting an account of a winner of the online game with an amount corresponding to the prize amount designation.

26. The method of claim 25, wherein the prize amount designation specifies an amount to be awarded for a first-place winner and at least one other place winner; and wherein crediting includes crediting an account of the at least one other place winner with the amount designated.

27. The method of claim 22 wherein a prize field is maintained for an online game to store the prize amount for an online game.

28. The method of claim 27 wherein the prize field comprises markers indicating the identified amounts for each player of an online game.

29. The method of claim 28 further comprising:
responsive to determining a winner of an online game, debiting online accounts of players not qualifying as a winner for amounts equal to amounts specified by the markers.

30. A method of providing an online gaming system and an online store comprising:
providing an online game in which prize amounts are awarded responsive to online currency received from players of the online game to fund the prize amount; and
providing access to goods to be sold in an online store, wherein goods can be purchased by players using online currency awarded to the players from online games.

31. The method of claim 30 wherein the online store is maintained by an entity providing the online game.

32. The method of claim 30 wherein the online store is maintained by a third party entity.

33. The method of claim 30 further comprising:
checking payment ability of a player depositing online currency into an online currency account.

34. The method of claim 33, further comprising:
responsive to a payment ability check indicating that a player has sufficient resources to deposit a specified amount of online currency, crediting the online account of the player with the specified amount.

35. The method of claim 34 further comprising:
responsive to crediting an online account, not requiring checking the payment ability of a player when the player specifies a prize amount, responsive to the specified prize amount being less than the amount in the player's account.

36. The method of claim 34 further comprising:
responsive to crediting an online account, not requiring checking the payment ability of a player when the player specifies a good to be purchased, responsive to a cost of the specified good to be purchased being less than the amount in the player's account.
